(19) United States
(12) Patent Application Publication
(10) Pub. No.: US 2010/0026181 A1
(43) Pub. Date: Feb. 4, 2010

(54) CERAMIC DISCHARGE VESSEL AND METHOD OF MAKING SAME

(75) Inventors: Victor Perez, Manchester, NH (US); James Avallon, Beverly, MA (US); Jeffrey T. Neil, North Reading, MA (US)

Correspondence Address: OSRAM SYLVANIA INC, 100 ENDICOTT STREET, DANVERS, MA, 01923, US

(73) Assignee: OSRAM SYLVANIA INC., Danvers, MA (US)

(21) Appl. No.: 12/184,811

(22) Filed: Aug. 1, 2008

(51) Int. Cl. H01J 17/18; H01J 9/02

(52) U.S. Cl. 313/623; 445/26

(57) ABSTRACT

A ceramic discharge vessel has a hollow body with at least one receptor. A molybdenum tube is shrink-fit in the receptor, preferably in the form of capillaries. The shrink fit provides a hermetic seal without the use of glass frits or other additional sealing materials. An electrode having a rod portion is inserted into the molybdenum tube. The rod portion of the electrode is welded to the tube at a remote end of the tube. The inner diameter of the molybdenum tube is no more than 0.02 mm greater than the outer diameter of the rod portion of the electrode so that a gap of 0.01 mm or less is formed between the rod portion and the tube to inhibit pooling of the discharge medium, e.g., a metal halide fill, in the gap.

### TECHNICAL FIELD

This application relates to discharge lamps and more particularly to ceramic discharge vessels therefor and methods of making such discharge vessels.

### BACKGROUND ART

Recent developments in high intensity discharge lamps, in particular metal halide lamps, have led to the use of ceramic discharge vessels in place of the previous discharge vessels formed from quartz. The use of the ceramic discharge vessels has led to many advantages; however, sealing problems involved in hermetically sealing electrodes into the ceramic discharge vessels have limited their use somewhat. Sealing electrodes into the ceramic has involved using various glass frits or other sealing compounds to accommodate the differences in thermal expansion between the metallic electrodes and ceramic.

While the use of glass frits has proved workable, its use has many disadvantages. The main disadvantage relates to the fact that the glass frits are reactive with the standard metal halide fills. The higher the temperature at which the discharge vessel operates, the higher the reaction rate will be. To minimize the reaction rate, so as to minimize the effect such reactions have on lamp performance, the discharge vessel must be designed in such a way as to keep the glass frit sealing compound from reaching temperatures where they would react rapidly with the metal halide fill (typically mercury and a mixture of metal iodides). This temperature limitation typically necessitates the discharge vessel to be designed with long capillaries extending from the discharge vessel body. At the far end, that is, the end of the capillary remote from the discharge vessel body, the temperature is low enough so as not to cause a severe problem. It is at this remote end that the glass frit hermetically seals the electrode into the ceramic. This solution to the sealing problem presents its own constraints. First, the discharge vessel is more difficult and expensive to produce. Second, the long capillaries increase the size of the discharge vessel, limiting design flexibility, especially by hindering the miniaturization of the lamp employing the discharge vessel, a relatively constant demand of the marketplace. Third, the elongated capillaries provide an discharge vessel with “cold” spaces or reservoirs, where components of the fill can condense and remain permanently or temporarily out of the plasma discharge. These fill components entering and leaving the plasma discharge in an uncontrolled manner can, and do, cause unwanted color shifts in the lamp output.

Accordingly, it would be an advance in the art to provide a seal between a ceramic member and metal member without the use of intermediate sealing materials.

### SUMMARY OF THE INVENTION

It is, therefore, an object of the invention to obviate the disadvantages of the prior art.

It is another object of the invention to enhance ceramic discharge vessels.

Yet another object of the invention is the improvement of ceramic discharge vessels and methods of making the same.

The objects are accomplished in one aspect of the invention by the provision of a ceramic discharge vessel comprising a hollow body having at least one tubular receptor extending from the hollow body. A molybdenum tube is joined to the receptor at a hermetic seal, the hermetic seal occurring in the absence of any intermediate sealing compound. An electrode is inserted into the molybdenum tube. The electrode has a rod portion that is welded to the molybdenum tube at a remote end of the molybdenum tube. The inner diameter of the molybdenum tube is no more than 0.02 mm greater than the outer diameter of the rod portion of the electrode so that a gap of 0.01 mm or less is formed between the rod portion and the molybdenum tube.

The objects are further accomplished by a method of making a ceramic discharge vessel comprising the steps of:

forming a hollow ceramic body having at least one tubular receptor projecting from the body and firing the body in air to remove binder material and pre-sinter the body;

inserting a molybdenum tube into the receptor to form a subassembly and firing the subassembly in a hydrogen-containing atmosphere to hermetically seal the receptors to the molybdenum tube without the use of any intermediate bonding agents;

inserting an electrode into the molybdenum tube, the electrode having a rod portion, the inner diameter of the molybdenum tube being no more than 0.02 mm greater than the outer diameter of the rod portion of the electrode so that a gap of 0.01 mm or less is formed between the rod portion and the molybdenum tube; and

welding the rod portion of the electrode to the molybdenum tube at a remote end of the molybdenum tube.

In a preferred embodiment, the method comprises the steps of:

forming a hollow, bulbous body of alumina, the body having two tubular receptors extending from opposite sides along a longitudinal axis of the discharge vessel;

firing the body at about 900° C. in air to remove binder material and pre-sinter the body;

inserting a molybdenum tube into each receptor to form a subassembly;

firing the subassembly at about 1820 to about 1850° C. in hydrogen to hermetically seal the receptors to the molybdenum tubes without the use of any intermediate bonding agents;

inserting a first of two electrodes into a first of the molybdenum tubes, the electrodes each having a rod portion, the inner diameter of the molybdenum tubes being no more than 0.02 mm greater than the outer diameter of the rod portions of the electrodes so that a gap of 0.01 mm or less is formed between the rod portions and the molybdenum tubes;
welding a remote end of the first molybdenum tube to the rod portion of the first electrode;
dispensing an arc generating and sustaining medium into the hollow body through the second of the molybdenum tubes;
inserting the second of the two electrodes into the second of the molybdenum tubes; and
welding a remote end of the second molybdenum tube to the rod portion of the second electrode.

### BRIEF DESCRIPTION OF THE DRAWINGS

FIG. 1 is a sectional view of a ceramic discharge vessel prior to sealing;

FIG. 2 is a sectional view of a ceramic discharge vessel after joining to molybdenum tubes according to an embodiment of the invention;

FIG. 3 is an illustration of an electrode for inserting into the molybdenum tube according to an embodiment of the invention;

FIG. 4 is a partial, sectional view of a ceramic discharge vessel according to an embodiment of the invention;

FIG. 5 is a similar view of an alternate embodiment of the invention;

FIG. 6 is a sectional view of an alternate embodiment of the invention shown without an electrode; and

FIG. 7 is a partial view of yet another embodiment of the invention.

### DETAILED DESCRIPTION THE INVENTION

For a better understanding of the present invention, together with other and further objects, advantages and capabilities thereof, reference is made to the following disclosure and appended claims taken in conjunction with the above-described drawings.

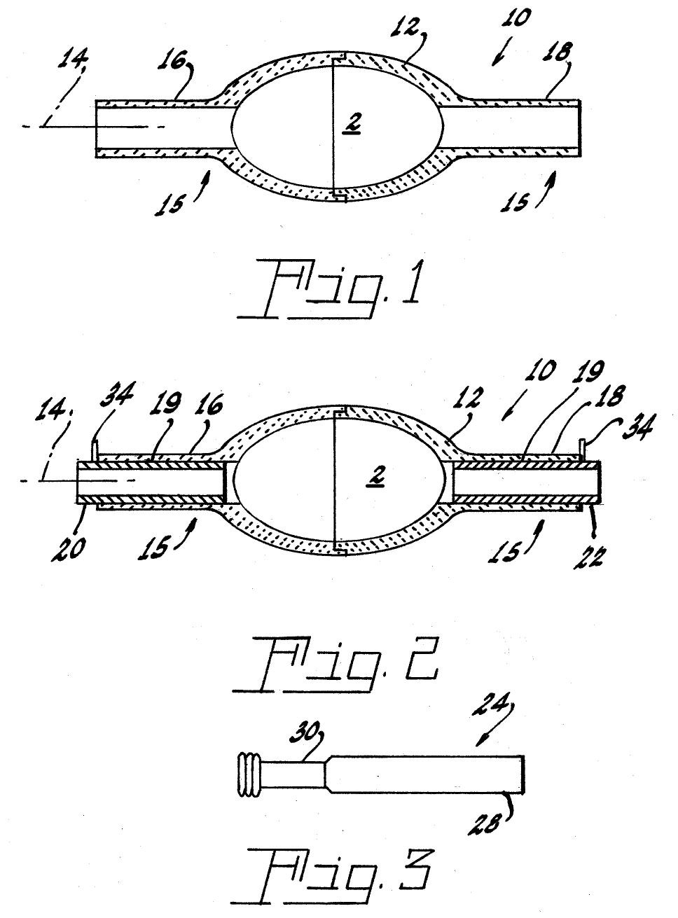

Referring now to the drawings with greater particularity, there is shown in FIG. 1 a ceramic discharge vessel 10 prior to sealing. The discharge vessel comprises hollow body 12 having at least one receptor 15 and enclosing discharge space 2. Preferably, the hollow body 12 is symmetric about longitudinal axis 14 and has a bulbous shape (although other shapes such as cylindrical or elliptical are possible). The hollow body 12 is preferably comprised of polycrystalline alumina (PCA) but may also be made of other translucent or transparent ceramic materials such as aluminum nitride, aluminum oxynitride, or yttrium aluminum garnet. In a preferred embodiment, receptors 15, which can be in the form of tubular capillaries 16, 18, extend from opposite sides of the bulbous body 12 along longitudinal axis 14. It is preferred that the receptors 15 are made of the same ceramic material as the hollow body 12 and are integrally formed with the hollow body (which can be made in two parts joined together by a central seam as shown in FIG. 1). Before further sealing to the metal components, the formed hollow body is pre-sintered to remove binder materials by firing in air to 900° C. for 120 minutes.

In a next step (FIG. 2), molybdenum tubes 20, 22 respectively, are placed a given distance into each of the receptors 15. In a preferred embodiment of the invention, the pre-sintered body will have receptors with an inside diameter of about 1.3 mm and the molybdenum tubes will have an outside diameter of 1 to 1.2 mm and an inside diameter of about 0.76 to 0.79 mm. A wall thickness of <0.22 mm is recommended. The body 12 with the molybdenum tubes in place is then fired in hydrogen at a temperature of about 1820 to about 1850° C. for 240 minutes to sinter the body and join the capillaries 16, 18 to the tubes 20, 22 at a hermetic seal 19, the hermetic seal 19 occurring in the absence of any intermediate sealing compound, such as the glass frits previously employed.

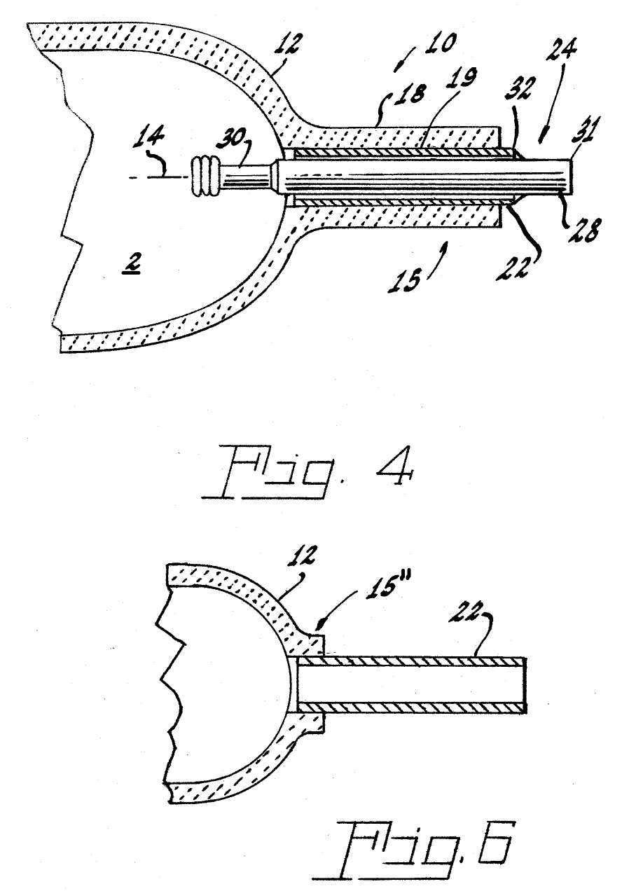

After sealing the molybdenum tubes to the receptors, electrodes 24 (FIG. 3) are inserted to finish the discharge vessel. In a preferred embodiment, each of the electrodes 24 comprises a rod portion 28 (preferably made of molybdenum) and has a tungsten electrode 30 fixed to one end thereof. The molybdenum tubes 20, 22 preferably have an inside diameter that is no more than 0.02 mm greater than the outside diameter of the rod portions 28 so that a gap of 0.01 mm or less is formed between the rod portion 28 and its respective tube 20, 22. The gap is sufficiently small to inhibit the arc generating and maintaining fill from pooling in the space.

Referring now to FIG. 4, the rod portion 28 of the electrode 24 is hermetically sealed to its respective molybdenum tube 20, 22 by welding the rod portion 28 to a remote end 32 of the tube 22, i.e., the end of the tube 22 furthest away from the discharge space 2 of hollow body 12. Preferably, the molybdenum tube is laser welded to a molybdenum rod portion resulting in a molybdenum-to-molybdenum seal that does not introduce any extraneous material. An end 31 of electrode 24 preferably protrudes beyond the remote end 32 of tube 22 in order to provide a more convenient means of attaching the electrical supply lead (not shown) to the discharge vessel.

Before finally sealing the discharge vessel, the arc generating and sustaining medium (i.e., the fill, usually comprised of one or more metal salts, as is known) is inserted into the body 12 through an open tube, which then has an electrode 24 inserted and sealed, by welding, to the tube.

The following non-limiting examples illustrate the invention more particularly.

### EXAMPLE I

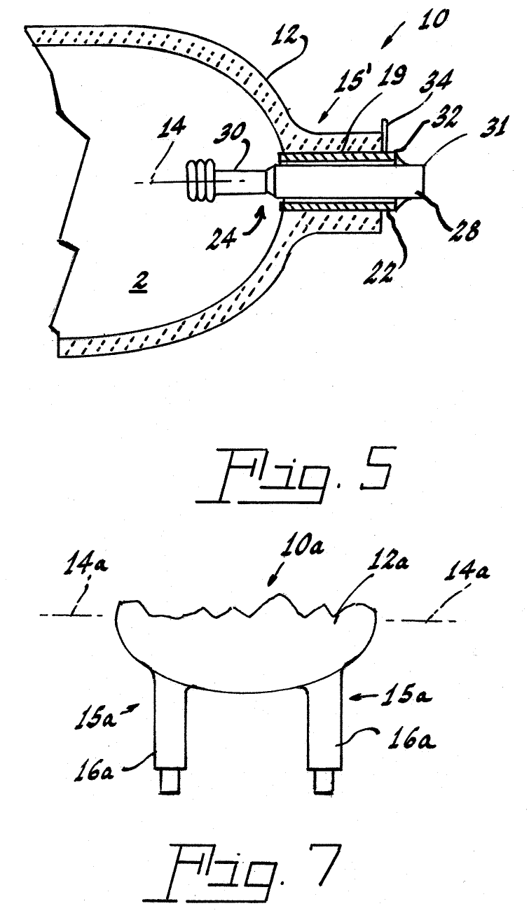

A molded discharge vessel body 12, such as one for a 70 W discharge vessel, and having a receptor inside diameter of about 1.11 mm (designed to have a finished inside diameter of 0.83 mm) is pre-sintered by firing in air at about 900° C. to remove any binder material. The pre-sintered body is then fitted with a molybdenum tube of 1.0 mm O.D. and 0.76 mm I.D. in each receptor. If desired, a stop wire 34 (FIGS. 2 and 5) can be welded to the outside of the molybdenum tubes to determine insertion distance. Preferably, the body is mounted vertically in the final sintering furnace by threading a temporary tungsten rod of a suitable diameter (0.7 mm in this instance) through the molybdenum tubes. The tungsten rod maintains the axial alignment between the two molybdenum tubes. During sintering, the capillaries shrank onto the molybdenum tubes as the ceramic densified. After sintering, the temporary tungsten rod was removed and the ceramic appeared to be tightly conformed to the molybdenum tube in each capillary. No cracks were apparent in the ceramic and the bond was tested by helium leak testing and showed no leakage. The shrink fit ratio of the molybdenum tube with the ceramic capillaries was 1.00 mm divided by 0.83 mm or about 20.5%.

### EXAMPLE II

A molded discharge vessel body 12, for a 70 W discharge vessel, designed to have a capillary inside diameter of 0.95 mm upon completion, was pre-sintered as above. Molybdenum tubes 20, 22, having an O.D. of 1.2 mm and an I.D. of 0.8 mm, were inserted into each receptor and the assembly threaded on to a temporary tungsten rod as above. Final sintering was again carried out at between 1820 and 1850° C. in a hydrogen atmosphere for 240 minutes. During sintering, the capillaries shrank onto the molybdenum tubes with a shrink fit. After sintering, the bond was tested by helium leak testing and showed no leakage and no cracks. The shrink fit ratio of the molybdenum tubing with the ceramic capillaries was 1.2 mm divided by 0.95 mm or about 26.3%.

To determine the efficacy of this procedure if solid, as opposed to tubular, molybdenum structures were employed, the above tests were repeated with solid molybdenum rods used in place of the molybdenum tubes. In a first instance, a capillary designed to have an inside diameter of 0.95 after sintering was fitted with a solid molybdenum rod of 1.01 mm diameter. The final sinter procedure was as described above. After sintering, the ceramic appeared to be not as tightly conformed to the solid rods. Large cracks were apparent in the ceramic along the rod length and the bond was not considered to be leak tight. The shrink fit ratio of the molybdenum rod with the ceramic capillaries was 1.01 mm divided by 0.95 mm or about 6.3%.

In a second instance, a similar body to that described above was fitted with solid molybdenum rods of 1.11 mm diameter. Final sintering was as described above with reference to Examples I and II and the first instance of the molybdenum rods. Again, after sintering, the ceramic appeared to be not tightly bonded and large cracks were apparent. The bond was not leak-tight. The shrink fit ratio of the molybdenum rod with the ceramic capillaries was 1.11 mm divided by 0.95 mm or about 16.8%.

In the examples described above the receptors were trimmed to provide an overall capillary length of 38 mm for the discharge vessel after final sintering.

To determine if the ceramic capillary length could be effectively shortened, a molded discharge vessel designed to have a capillary inside diameter of 0.95 was used. The capillaries were trimmed to provide a receptor 15 with a shortened overall length of about 27.7 mm after final sintering. Hollow bodies with shorter receptors 15′, 15″ are shown in FIGS. 5 and 6, respectively. The discharge vessel binder removal and pre-sintering in air were performed as above. Molybdenum tubes of 1.2 mm diameter were inserted into each receptor to a depth of about 9.7 mm as determined by a wire stop position. This position was calculated to be the position needed to place the ends of the molybdenum tubes just outside of the discharge vessel cavity. Final sintering occurred as before. No cracks were apparent in the ceramic and the bond was successfully leak-tested by the helium leak test method.

The versatility of this construction is further illustrated by the embodiment shown in FIG. 7 wherein an discharge vessel 10a has a body 12a that is formed about a horizontal axis 14a and the receptors 15a (or capillaries 16a) extend in a direction normal to that of the horizontal axis 14a. Processing times, temperatures and tolerances for this construction are the same as those previously described.

The benefits derived from this discharge vessel and the method of making it are many. The bond that is formed requires no frit seals or extra material, as do the prior art procedures. This, alone, provides a cost saving. Also, the tenacity of the seal allows a given wattage discharge vessel to made smaller, by shortening the receptors or capillaries, also a highly desired result.

While there have been shown and described what are at present considered to be the preferred embodiments of the invention, it will be apparent to those skilled in the art that various changes and modifications can be made herein without departing from the scope of the invention as defined by the appended claims.

What is claimed is:

1. A ceramic discharge vessel comprising:
a hollow body having at least one tubular receptor extending from the hollow body;
a molybdenum tube joined to the receptor at a hermetic seal, the hermetic seal occurring in the absence of any intermediate sealing compound; and
an electrode inserted into the molybdenum tube, the electrode having a rod portion that is welded to the molybdenum tube at a remote end of the molybdenum tube, the inner diameter of the molybdenum tube being no more than 0.02 mm greater than the outer diameter of the rod portion of the electrode so that a gap of 0.01 mm or less is formed between the rod portion and the molybdenum tube.

2. The ceramic discharge vessel of claim 1 wherein the hollow body is symmetric about a longitudinal axis.

3. The ceramic discharge vessel of claim 2 wherein the discharge vessel has two tubular receptors that are positioned at opposite sides of the discharge vessel along the longitudinal axis.

4. The ceramic discharge vessel of claim 1 wherein the rod portion of the electrode is made of molybdenum.

5. The ceramic discharge vessel of claim 1 wherein the discharge vessel contains a metal halide fill.

6. The ceramic discharge vessel of claim 1 wherein the hollow body is comprised of polycrystalline alumina.

7. A method of making a ceramic discharge vessel, comprising the steps of:
forming a hollow ceramic body having at least one tubular receptor projecting from the body and firing the body in air to remove binder material and pre-sinter the body;
inserting a molybdenum tube into the receptor to form a subassembly and firing the subassembly in a hydrogen-containing atmosphere to hermetically seal the receptor to the molybdenum tube without the use of any intermediate bonding agents;
inserting an electrode into the molybdenum tube, the electrode having a rod portion, the inner diameter of the molybdenum tube being no more than 0.02 mm greater than the outer diameter of the rod portion of the electrode so that a gap of 0.01 mm or less is formed between the rod portion and the molybdenum tube; and
welding the rod portion of the electrode to the molybdenum tube at a remote end of the molybdenum tube.

8. The method of claim 7 wherein the rod portion is laser welded to the molybdenum tube.

9. The method of claim 8 wherein the rod portion is made of molybdenum.

10. The method of claim 7 wherein the hollow body is comprised of polycrystalline alumina.

11. A method of making a ceramic discharge vessel, comprising the steps of;
forming a hollow, bulbous body of alumina, the body having two tubular receptors extending from opposite sides along a longitudinal axis of the discharge vessel;
firing the body at about 900° C. in air to remove binder material and pre-sinter the body;
inserting a molybdenum tube into each receptor to form a subassembly;
firing the subassembly at about 1820 to about 1850° C. in hydrogen to hermetically seal the receptors to the molybdenum tubes without the use of any intermediate bonding agents;
inserting a first of two electrodes into a first of the molybdenum tubes, the electrodes each having a rod portion, the inner diameter of the molybdenum tubes being no more than 0.02 mm greater than the outer diameter of the rod portions of the electrodes so that a gap of 0.01 mm or less is formed between the rod portions and the molybdenum tubes;
welding a remote end of the first molybdenum tube to the rod portion of the first electrode;
dispensing an arc generating and sustaining medium into the hollow body through the second of the molybdenum tubes;
inserting the second of the two electrodes into the second of the molybdenum tubes; and
welding a remote end of the second molybdenum tube to the rod portion of the second electrode.

12. The method of claim 11 wherein the rod portions of the electrode are made of molybdenum and the welding of the rod portions to the molybdenum tubes comprises laser welding.
